(19) United States
(12) Patent Application Publication
(10) Pub. No.: US 2011/0239705 A1
(43) Pub. Date: Oct. 6, 2011

(54) DECORATIVE JEWEL AND METHOD FOR CUTTING DECORATIVE JEWEL

(75) Inventors: Tamotsu Matsumura, Kanagawa (JP); Yoshinori Kawabuchi, Tokyo (JP); Akira Itoh, Tokyo (JP)

(73) Assignee: HOHOEMI BRAINS, INC., Chuo-ku, Tokyo (JP)

(21) Appl. No.: 13/120,888

(22) PCT Filed: Sep. 24, 2009
(86) PCT No.: PCT/JP2009/066512

§ 371 Date: Jun. 13, 2011

(30) Foreign Application Priority Data
Sep. 25, 2008 (JP) 2008-246705

(51) Int. Cl. A44C 17/00; B28D 5/00

(52) U.S. Cl. 63/32; 125/30.01

(57) ABSTRACT

The color stone 1 is formed of a material with a refractive index n of 1.55 to 2.40, and is subjected to round brilliant-cutting. The pavilion angle p and the crown angle c satisfy the correlation of,

−A(n)×p+B(n)+K1≧c≧−A(n)×p+B(n)+K2

where, A(n) is represented by

A(n)=−1.122×n⁵+9.14×n⁴−26.752×n³+32.982×n²−12.842×n,

B(n) is represented by

B(n)=−22.323×n⁵+184.166×n⁴−527.616×n³+594.102×n²−128.68×n,

K1 is represented by

K1=+4, and

K2 is represented by

K2=−4.

### TECHNICAL FIELD

The present invention relates to a decorative jewel formed of a material with a refractive index n of 1.55 to 2.40 and being subjected to brilliant-cutting, and to a method of cutting thereof.

### BACKGROUND ART

Diamond is a typical decorative jewel. The entire value of diamonds is evaluated by the value of a rough diamond, such as carat (weight), color, and clarity (mass and quantity of inclusions), together with the value added by human work such as cutting (proportion, symmetry, and polish). In the evaluation of diamond's value, except for the evaluation of value by carat, higher evaluation is given to a diamond which is more close to being colorless and transparent in terms of color and clarity. Furthermore, higher evaluation is given to the one having higher brightness degree such as brilliance and scintillation caused by cutting, rather than depth of color. The brightness degree is normally calculated as the quantity of physical reflection light, which is the total amount of rays reflected in the diamond among the incident rays from the outside.

As a cut design of diamond for increasing the brightness degree by the increase in the quantity of physical reflection light, there is the one proposed by Tolkowsky, a mathematician. He cut a diamond by brilliant-cutting to provide 58-facets giving a pavilion angle p of 40.75 degrees, a crown angle c of 34.50 degrees, and a table diameter of 53% to the girdle diameter, which is accepted as an ideal cut.

In contrast, there are color stones such as ruby and sapphire as decorative jewels other than diamond. Those color stones have the respective independent colors (for example, vermilion for ruby and blue for sapphire), and the evaluation of value of color stones tends to emphasize the depth of color rather than brightness degree except for the evaluation by weight. As a result, there are not many techniques for increasing the brightness degree of color stones, and as a general technique for improving the brightness of decorative jewels, there has only been proposed a technique for cutting decorative jewels including both diamond and color stones in response to the refractive index n of the material so that the pavilion angle and the crown angle reach the respective specified values (for example, refer to Patent Document 1).

### CITATION LIST

### Patent Literature

Patent Document 1: U.S. Pat. No. 4,083,352

### SUMMARY OF INVENTION

### Technical Problem

The viewpoint in which a person feels that a color stone is beautiful should include brightness degree similar to diamond, in addition to the depth of color. However, compared with a diamond which has been studied for a long period in terms of cut-design for increasing the brightness degree, color stones have different refractive index from that of diamond, (for example, the refractive index of diamond is 2.42, and the refractive index of ruby and sapphire is 1.762), and thus even if the cutting technique of diamond is applied to color stones, it has been difficult to increase the brightness degree of color stones. In addition, refractive index differs even among color stones because the refractive index of emerald is 1.577, whereas, for example, that of ruby is 1.762, and thus there has been required a cutting condition which can be commonly used among different kinds of color stones.

When judging the brightness degree of a color stone, the quantity of physical reflection light, or the total amount of rays reflected in the color stone, and the brightness degree by which a person feels the beauty do not necessarily coincide with each other, and thus there have been required color stones having a higher brightness degree by which a person feels the beauty.

The present invention has been made in the light of the above situations, and an object of the present invention is to provide a decorative jewel subjected to cut-design which allows viewers to feel that brightness of color stones is further beautiful.

Furthermore, the present invention has been made in the light of the above situations, and another object of the present invention is to provide a cutting method in which cutting condition for cut-design which allows viewers to feel that brightness of color stones is further beautiful, can be commonly used among different kinds of color stones.

### Solution to Problem

The inventors of the present invention have conducted detail study to solve the above problems, and have focused attention on the fact that letting viewers further feel the beauty of the brightness of color stone subjected to brilliant-cutting should be not on the basis of the amount of physical reflection light or the total amount of reflected rays, but on the basis of the “quantity of reflection light on visual perception” based on the quantity of light viewer can perceive. Then, the inventors of the present invention have further conducted the study on the cutting design capable of increasing the “quantity of reflection light on visual perception”, and have found that there is a specific correlation between the cutting condition in brilliant-cutting, such as pavilion angle and crown angle for increasing the “quantity of reflection light on visual perception”, and the refractive index which differs depending on the kinds of color stones. Therefore, the inventors of the present invention have obtained a finding that the respective color stones offer further beauty in the brightness of different refractive indexes if only the pavilion angle and the crown angle as the cutting condition can be determined by substituting the refractive index of color stone into the above-described correlation, thus having perfected the present invention.

The decorative jewel according to the present invention is the one formed of a material with a refractive index n of 1.55 to 2.40 and being subjected to brilliant-cutting, wherein the pavilion angle p and the crown angle c satisfy the formula (1),

−A(n)×p+B(n)+K1≧c≧−A(n)×p+B(n)+K2 (1)

where, A(n) in the formula (1) is represented by the formula (2),

A(n)=−1.122×n⁵+9.14×n⁴−26.752×n³+32.982×n²−12.842×n (2)

B(n) in the formula (1) is represented by the formula (3),

B(n)=−22.323×n⁵+184.166×n⁴−527.616×n³+594.102×n²−128.68×n (3)

K1 in the formula (1) is represented by the formula (4),

K1=+4 (4)

K2 in the formula (1) is represented by the formula (5),

K2=−4 (5)

when the refractive index n is from 1.70 to 1.90, and the pavilion angle p is larger than 41 degrees and not larger than 43 degrees, K2 in the formula (1) is represented by the formula (6) instead of the formula (5),

K2=−10.526(0.38²−(n−2.1)²)^{1/2} (6)

The method of cutting decorative jewel according to the present invention is the cutting method of decorative jewel formed of a material with a refractive index n of 1.55 to 2.40 and being subjected to brilliant-cutting, and the method comprises the step of cutting decorative jewel so that the pavilion angle p and the crown angle c satisfies the formula (1),

−A(n)×p+B(n)+K1≧c≧−A(n)×p+B(n)+K2 (1)

where, A(n) in the formula (1) is represented by the formula (2),

A(n)=−1.122×n⁵+9.14×n⁴−26.752×n³+32.982×n²−12.842×n (2)

B(n) in the formula (1) is represented by the formula (3),

B(n)=−22.323×n⁵+184.166×n⁴−527.616×n³+594.102×n²−128.68×n (3)

K1 in the formula (1) is represented by the formula (4),

K1=+4 (4)

K2 in the formula (1) is represented by the formula (5),

K2=−4 (5)

when the refractive index n is from 1.70 to 1.90, and the pavilion angle p is larger than 41 degrees and not larger than 43 degrees, K2 in the formula (1) is represented by the formula (6) instead of the formula (5),

K2=−10.526(0.38²−(n−2.1)²)^{1/2} (6)

According to the decorative jewel and the method of cutting decorative jewel of the present invention, the pavilion angle p and the crown angle c satisfy the formula (1), −A(n)×p+B(n)+K1≧c≧−A(n)×p+B(n)+K2. To that correlation of the formula (1), by substituting any of the different refractive indexes of 1.55 to 2.40 in the formula (1), and performing cut-design in which pavilion angle p and the crown angle c are determined, the “quantity of reflection light on visual perception” can be increased responding to the refractive index n, and allowing viewers of thus cut-designed decorative jewel to feel that brightness of the decorative jewel is further beautiful becomes possible. Furthermore, according to the formula (1), since the pavilion angle p and the crown angle c are determined responding to the refractive index n, the cut-condition capable of increasing the “quantity of reflection light on visual perception” can be used commonly among the different kinds of color stones.

The decorative jewel according to the present invention preferably has the pavilion angle p of 38 to 43 degrees when the refractive index n is larger than 1.70 and not larger than 2.40. As a result, the “quantity of reflection light on visual perception” can further be increased when the refractive index n is larger than 1.70 and not larger than 2.40. Furthermore, the decorative jewel according to the present invention preferably has the crown angle c of 14 degrees or larger when the refractive index n is from 2.30 to 2.40. Thus, the “quantity of reflection light on visual perception” can further be increased, and allowing viewers to feel that brightness of the decorative jewel is further beautiful becomes possible.

The decorative jewel according to the present invention preferably has the pavilion angle p of 38 to 41 degrees (larger than the critical angle, sin⁻¹(1/n)) when the refractive index n is from 1.55 to 1.70. As a result, the “quantity of reflection light on visual perception” can further be increased when the refractive index n is in the range from 1.55 to 1.70.

### Advantageous Effects of Invention

According to the present invention, the “quantity of reflection light on visual perception” can be increased, thus the viewer can have more beautiful feeling of the brightness of the color stone.

### BRIEF DESCRIPTION OF DRAWINGS

FIG. 1 is a side view of a color stone subjected to round brilliant-cutting according to an embodiment.

FIG. 2 is a plan view of the color stone shown in FIG. 1.

FIG. 3 is a bottom view of the color stone shown in FIG. 1.

FIG. 4 is a cross-sectional view of the color stone shown in FIG. 1.

FIG. 5 is a schematic drawing illustrating an example of incident light and reflection light in the color stone shown in FIG. 1.

FIG. 6 is a table showing the absolute value of inclination and the y-slice value in a correlation giving the maximum reflection evaluation index, for each refractive index.

FIG. 7 is a graph showing the relation giving maximum reflection evaluation index for each refractive index.

FIG. 8 is a graph showing the relation between the pavilion angle p and the crown angle c at the refractive index n=2.40.

FIG. 9 is a graph showing the relation between the pavilion angle p and the crown angle c at the refractive index n=2.20.

FIG. 10 is a graph showing the relation between the pavilion angle p and the crown angle c at the refractive index n=2.00.

FIG. 11 is a graph showing the relation between the pavilion angle p and the crown angle c at the refractive index n=1.90.

FIG. 12 is a graph showing the relation between the pavilion angle p and the crown angle c at the refractive index n=1.80.

FIG. 13 is a graph showing the relation between the pavilion angle p and the crown angle c at the refractive index n=1.75.

FIG. 14 is a graph showing the relation between the pavilion angle p and the crown angle c at the refractive index n=1.70.

FIG. 15 is a graph showing the relation between the pavilion angle p and the crown angle c at the refractive index n=1.55.

### DESCRIPTION OF EMBODIMENTS

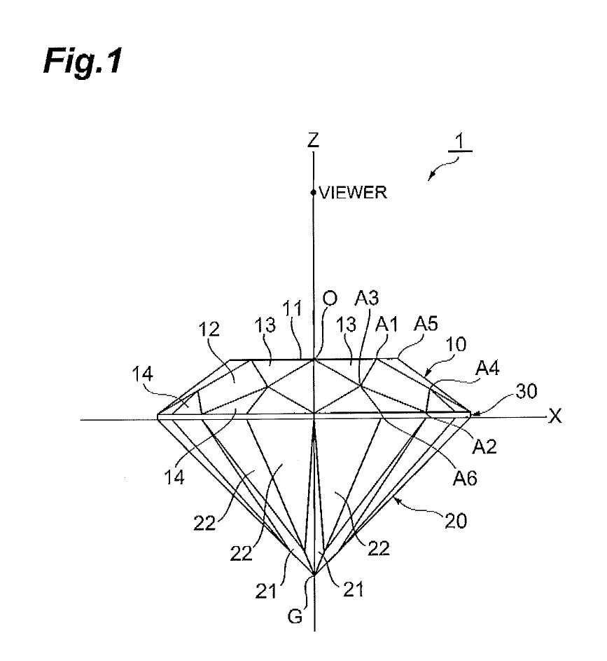

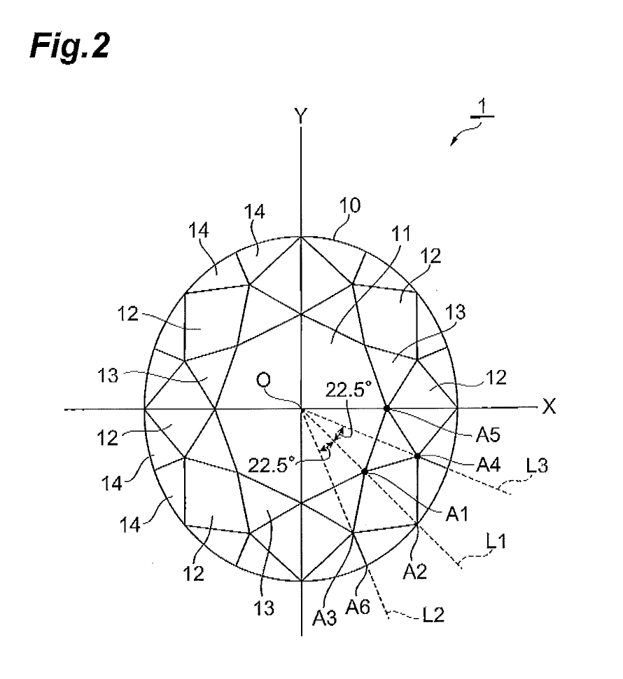

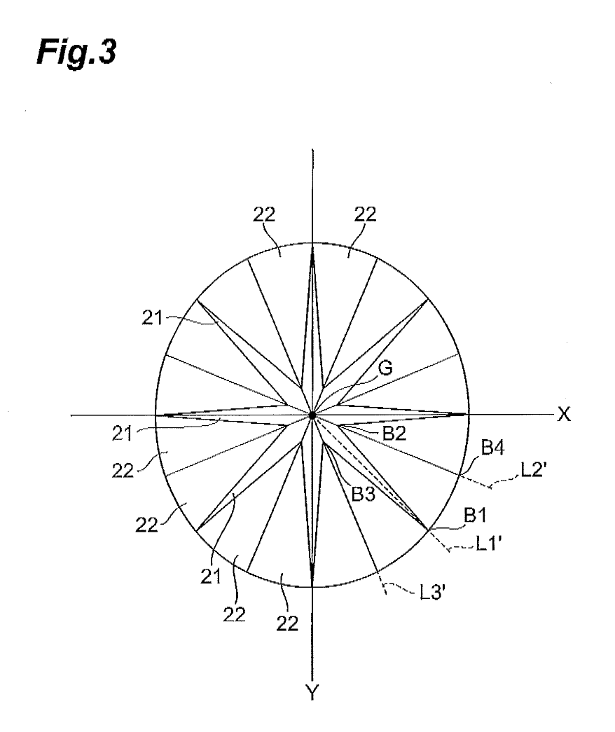

The embodiments of the present invention will be described in detail in the following referring to the drawings. In the description of the drawings, the same elements have the same reference symbol, and duplicated description is omitted. FIG. 1 shows a side view of a color stone (decorative jewel) subjected to round brilliant-cutting according to an embodiment, FIG. 2 shows a plan view of the color stone of FIG. 1, and FIG. 3 shows a bottom view of the color stone of FIG. 1. As illustrated in FIGS. 1 to 3, X axis and Y axis are selected so that these axes cross each other at 90 degrees in a horizontal plane, and Z axis is selected in the vertical direction thereto, which thus establishes the three dimensional orthogonal system. In the following description, the XYZ orthogonal system will be applied if necessary

A color stone 1 is the one formed of 58-facets polygon subjected to round brilliant-cutting, formed of, for example, a raw material such as ruby (refractive index n: 1.762) and sapphire (refractive index n: 1.762) with a smaller refractive index n than that of diamond, 2.42. Examples of other materials of color stone 1 are zirconia (refractive index n: 1.925), emerald (refractive index n: 1.577), aquamarine (refractive index n: 1.577), tourmaline (refractive index n: 1.624), and alexandrite (refractive index n: 1.746). The material is not necessarily limited to these, and any decorative jewel formed of the material with the refractive index of 1.55 to 2.40 can be used. The above-given refractive indexes n are determined by irradiation of sodium D-ray (589.3 nm) in a 20° C. atmosphere.

The color stone 1 formed of such a material has, as illustrated in FIG. 1, a crown part 10 formed in a near-truncated cone shape having a table surface 11 (refer to FIG. 2) in an octagonal shape formed at the viewer's side, a pavilion part 20 formed in a near-conical shape protruding against the culet G in Z axis opposite to the viewer side, and a girdle part 30 formed in a cylindrical shape between the bottom surface of the crown part 10 and the bottom surface of the pavilion part 20. The central axis line passing through the center O of the table surface 11 and through the culet G coincides with the Z axis in the XYZ coordinate system, and the plane of the girdle part 30 at culet G side (or the bottom surface of the pavilion part 20) coincides with the XY plane in the XYZ orthogonal system.

The description of the crown part 10 will be given below. As illustrated in FIG. 1 and FIG. 2, on outer periphery of the crown part 10 in a near-conical shape, there are: eight crown main facets (bezel facets) 12 formed so as to have equal spacing in a circumferential direction along the cone surface of the near-truncated cone; eight star facets 13 formed in the respective domains defined by an outer side of the table surface 11 being an apex of the near-truncated cone and by the two crown min facets 12 adjacent each other; and sixteen upper girdle facets 14 formed as the respective pair in the respective domains defined by the outer side of the girdle part 30 and the two crown main facets 12 adjacent each other.

As illustrated in FIG. 2, the crown main facet 12 is a plane in a quadrilateral shape having a pair apexes: the one apex (such as A1) of the octagonal table surface 11; and the other apex (such as A2) determined by extending a line connecting the apex A1 and the center O of the table surface 11 as L1, to thereby contact the outer side of the girdle part 30. The extended line L1 is inclined by centering on the center O of the table surface 11 by ±22.5 degrees along the XY plane, respectively, to form the extended and rotational lines L2 and L3, thereby forming the residual two apexes (for example, A3 and A4). The above-described apexes (for example, A3 and A4) in a single crown main facet 12 are shared as a single apex of the respective adjacent crown main facets 12 as a single apex, and the eight crown main facets 12 are connected each other via these apexes.

The star facet 13 is a triangle plane formed by two apexes (for example, A1 and A5) adjacent each other in an octagonal table surface 11 and an apex (for example, A4) shared with the two crown main facets 12 having each one of the two apexes (for example, A1 and A5). The star facet 13 has an apex owned jointly with the table surface 11, which apex is also shared with the adjacent star facet 13. As a result, eight star facets 13 are connected each other via these apexes.

The upper girdle facet 14 is a near-triangle plane defined by: a single side (for example, A2−A3) of the two sides intersecting with the outer side of the girdle part 30 among the four sides of the crown main facet 12, and the intersection (A6) of the extended and rotational line (for example, L2) of the extended line inclined to either side at ±22.5 degrees with the outer side of the girdle part 30. The upper girdle facet 14 and another upper girdle facet 14 formed in line-symmetry to the extended and rotational line share a side that coincides with the extended and rotational line, and thus eight pairs of triangle (total sixteen triangles) are formed.

Next, a description will be given of the pavilion part 20. As illustrated in FIG. 1 and FIG. 3, the pavilion part 20 has a portion called the culet G at the apex, and on the surface of a near-conical shape, there are: eight pavilion main facets 21; and sixteen lower girdle facets 22 formed as each pair in the domain defined by the outer side of the girdle part 30 and two pavilion main facets 21.

The pavilion main facet 21 is a quadrilateral plane having a pair apexes of the culet G as one apex and of an apex (for example B1) determined by extending the line between the culet G and the outer side of the girdle part 30, as an extended line L1′, to intersect with the outer side of the girdle part 30. The remaining two apexes (for example, B2 and B3) are formed on the extended and rotational lines L2′ and L3′ formed by inclining the extended line L1′ by centering on the culet G (that is Z axis) along the XY plane at ±22.5 degrees in both directions. The side connecting the apexes (for example, B2 and B3) on the extended and rotational lines L2′ and L3′ of the culet G in the pavilion main facet 21 is shared with the adjacent pavilion main facet 21. Thus, the eight pavilion main facets 21 are connected each other via that side. Since the extended line L1 defining the apex of the crown main facet 12 almost agrees with the extended line L1′ defining the apex of the pavilion main facet 21 on the XY plane, the crown main facet 12 and the pavilion main facet 21 are formed at a position almost facing each other with the girdle part 30 therebetween.

The lower girdle facet 22 is a near-triangle plane defined by a side (for example B1-B2) of the two sides intersecting with the outer side of the girdle part 30 among the four sides of the pavilion main facet 21 and the intersection (for example, B4) of the extended and rotational line (for example, L2′) with the outer side of the girdle 30. That kind of lower girdle facet 22 is formed, similar to the relation between the crown main facet 12 and the pavilion main facet 21, at a position almost facing each other with the upper girdle facet 14 and the girdle part 30 therebetween.

The girdle part 30 is in a cylindrical shape, and is formed so that the upper surface at viewer's side coincides with the bottom surface of the crown part 10, and so that the lower surface of the culet G side coincides with the bottom surface of the pavilion part 20, and thus the outer peripheral surface of the cylinder forms a surface of the 58-facets polygon. The upper surface at the viewer's side in the girdle part 30 is nearly parallel to the lower surface of the culet G side, and the upper surface at viewer side is parallel to the XY plane. Since the height of the girdle part 30 is normally designed so as to be minimized as far as possible, the following description may not specifically differentiate upper surface and lower surface in the girdle part 30, and may treat as the XY plane in the description.

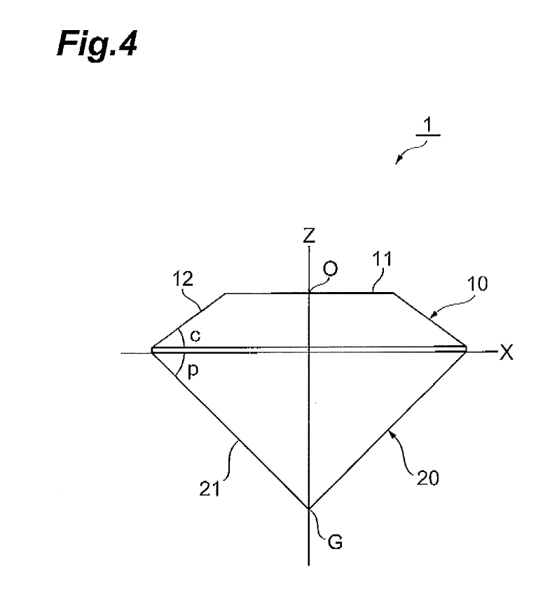

For the above-described color stone 1, a description will be given to the crown angle c and the pavilion angle p which are important variables to determine the brightness degree created by the reflection of incident light. FIG. 4 illustrates schematic cross section of the color stone 1 subjected to brilliant-cutting.

As illustrated in FIG. 4, the angle between the crown main facet 12 of the crown part 10 and the upper surface (that is, the XY plane) of the girdle part 30 is the crown angle c, and the angle between the pavilion main facet 21 of the pavilion part 20 and the lower surface (that is, the XY plane) of the girdle part 30 is the pavilion angle p. The crown main facet 12, the star facet 13, and the upper girdle facet 14, forming the crown part 10, are called the “crown surface”, and the pavilion main facet 21 and the lower girdle facet 22, forming the pavilion part 20, are called the “pavilion surface”.

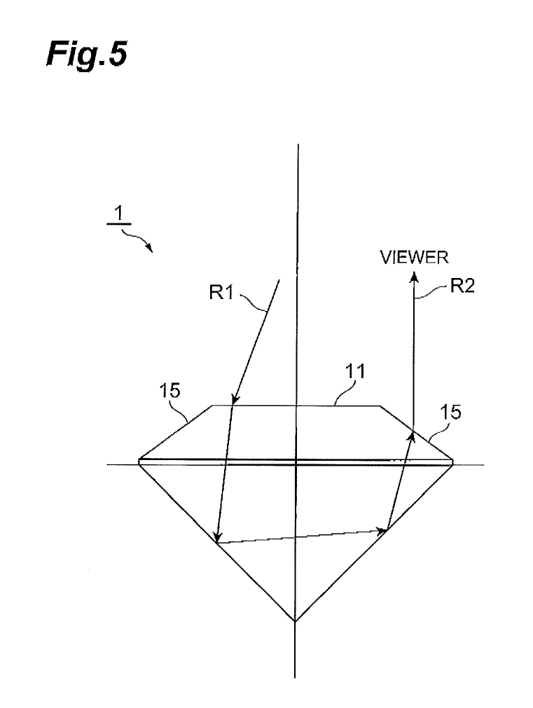

Next, a brief description will be given of the scheme of reflection of incident light from the outside in the color stone 1 to thereby generate the brightness. The color stone 1 is irradiated with lights generated from a light source uniformly distributed over the flat ceiling. When, for example, as illustrated in FIG. 5, a portion of the light enters from the table surface 11 of the color stone 1, the incident light R1 repeats the specific reflections in the color stone 1 to be left as the reflection light R2 from the crown surface 15 (at the right side in FIG. 5). Therefore, the viewer observes the reflection light R2 and recognizes that the brightness has been generated. That type of brightness is not only generated in the above-described route, but also the incident light entered from the crown surface 15 (at right side in FIG. 5) leaves from the reverse side of the crown surface 15 (at left side of FIG. 5) or the incident light entered from the table surface 11 leaves the table surface 11. In this manner, the incident light entered the color stone 1 is left as the reflection light after the repetition of the reflections inside the color stone 1 several times, and thus the reflection light patterns is generated on the facet surface of the color stone 1. Large number of reflection light patterns and strong reflection light enhance the brightness of the color stone 1, which improves the beauty of the color stone 1.

A portion of the incident light (such as the light of incidence angle of less than 20 degrees centering on the Z axis) is, however, shielded by the viewer, and the portion of the light does not enter the color stone 1 at a high probability, and the incident light of incidence angle larger than 45 degrees by centering on the Z axis has a low brightness owing to the attenuation by distance and is often shielded by an obstacle. Thus, those lights cannot be entered or cannot be reflected at a high probability. Accordingly, in evaluating the brightness degree, the incident light is determined in its light quantity in advance in consideration of the contribution ratio depending on the incidence angle centering on the Z axis.

The quantity of the reflection light as the origin of the brightness has been calculated as the quantity of physical reflection light such as the total amount of the reflection light. In the embodiment, however, the calculation is given as the reflection evaluation index based on the concept of the “quantity of reflection light on visual perception” which can be recognized by viewer.

The reflection evaluation index based on the concept of the “quantity of reflection light on visual perception” is described below. Since the visual perception of a person is generally given by the intensity of small light source as the quantity of stimulus, the reflection evaluation index means the quantity That is, the total amount of the physically derived reflection light is not adopted as the reflection evaluation index (or the amount of generated brightness), but the light amount in the reflection pattern is converted into the quantity of visual perception that the viewer feels as a stimulation, as the reflection evaluation index. Regarding such a conversion, for example, the Stevens Rule (refer to, for example, Takao Matsuda, “Visual Perception”, pp. 10-12, (2000), Baifukan Co., Ltd.) describes that, with a small light source, the quantity of visual perception felt by a person as stimulation is proportional to root of the physical light quantity.

The Stevens Rule is applied here to use the minimum physical reflection light amount which can be recognized aesthetically as the unit, and the multiple of the unit is used to express the light amount in every reflection pattern, then the root of the light amount is determined, and finally the total sum of the rood amounts is adopted as the reflection evaluation index. In determining the physical reflection light amount, the radius of the color stone 1 is divided into 200 equal meshes, and the amount of incident light considering the contribution of the incident light is determined in each mesh, and the sum of the amounts of incident light for the same pattern is adopted as the amount of the physical reflection light amount in the pattern. Since the color stone 1 has a radius of several millimeters, individual mesh becomes several hundreds of micro square meters. In consideration of the size that can be recognized by a person, the amount of visual perception (root of the physical light amount) is calculated only for the patterns having 100 or larger meshes, and the sum of them is adopted as the reflection evaluation index. The patterns having an area of less than 100 meshes are excluded from the reflection evaluation index because a person may have a possibility of being almost unrecognizable.

That is, the reflection evaluation index=Σ{(physical reflection light amount in consideration of the contribution ratio, for the patterns of 100 mesh or more)/(unit of the amount of the minimum recognizable physical reflection light)}^{1/2}. The symbol Σ means the total sum of the reflection patterns. When the reflection evaluation index exceeds 400, the viewer of the color stone 1 can feel that brightness of color stones is further beautiful,

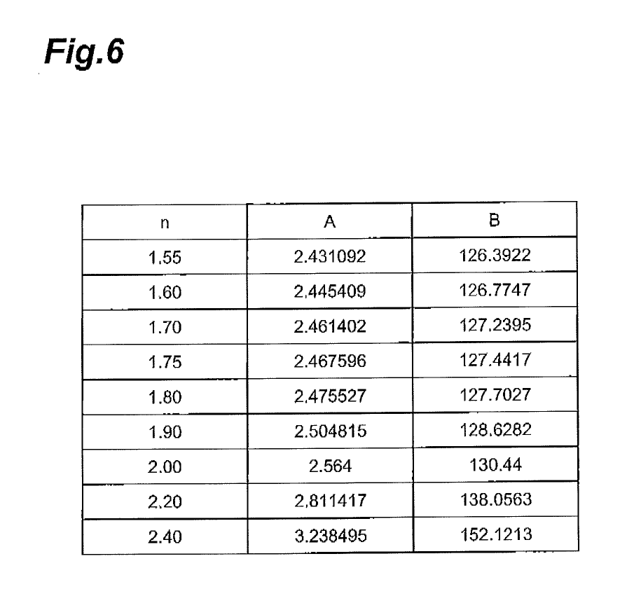

Next, with the above-described reflection evaluation index as the evaluation basis, the relation between the pavilion angle p and the crown angle c for giving the reflection evaluation index of 400 or more and giving maximum reflection evaluation index was determined for nine kinds of color stones 1 with the refractive index of 1.55 to 2.40, as given in FIG. 6. The reference sign n in the Table of FIG. 6 signifies the refractive index, and A and B represent the coefficients in the general formula (7),

c=−A(n)×p+B(n) (7)

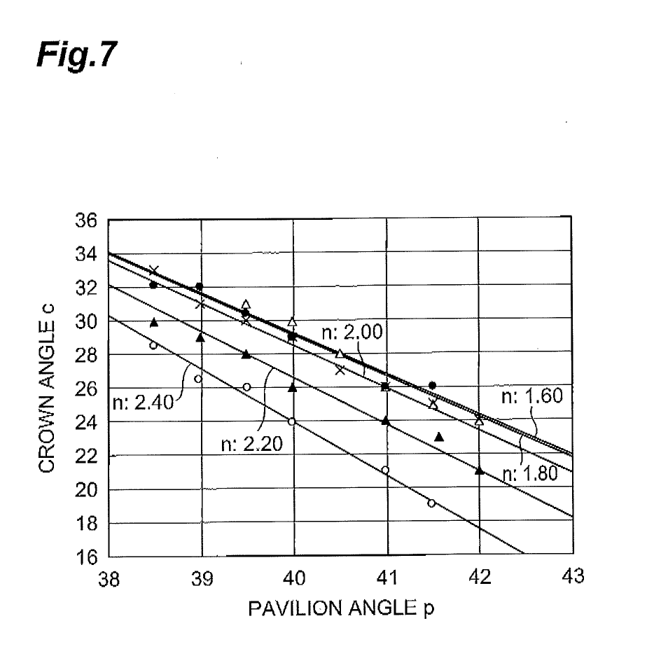

FIG. 7 gives the correlation formulae of five kinds of color stones 1 with the refractive index n of 1.60, 1.80, 2.00, 2.20, and 2.40, among the nine kinds of color stones 1.

Correlations for typical refractive indexes n are given below. For example, as apparent from FIG. 6 and FIG. 7, when the refractive index n is 1.60, the crown angle c is represented by the formula (8),

c=−2.4454×p+126.7747 (8)

When the refractive index n is 1.80, the crown angle c is represented by the formula (9),

c=−2.4755×p+127.7027 (9)

When the refractive index n is 2.00, the crown angle c is represented by the formula (10),

c=−2.564×p+130.44 (10)

When the refractive index n is 2.20, the crown angle c is represented by the formula (11),

c=−2.8114×p+138.0563 (11)

When the refractive index n is 2.40, the crown angle c is represented by the formula (12),

c=−3.2385×p+152.1213 (12)

When the above correlation is represented by the general formula (7) using the refractive index n as a parameter,

c=−A(n)×p+B(n) (7)

Then, A(n) becomes the formula (2),

A(n)=−1.122×n⁵+9.14×n⁴−26.752×n³+32.982×n²−12.842×n (2)

The B(n) becomes the formula (3),

B(n)=−22.323×n⁵+184.166×n⁴−527.616×n³+594.102×n²−128.68×n (3)

Therefore, as apparent from the above correlations, the color stone 1 formed of a material with the refractive index of 1.55 to 2.40 and being subjected to round brilliant-cutting gives the maximum reflection evaluation index with the highest brightness when the pavilion angle p and the crown angle c satisfy the above general formula (7) with the formulae (2) and (3), and the viewer can feel the highest beauty in the color stone 1.

The method of cutting that color stone 1 is achieved by a specific polishing so that the crown angle c and the pavilion angle p in the crown part 10 and the pavilion part 20 satisfy the general formula (7). Furthermore, the cutting method of color stone 1 with a 400 or larger reflection evaluation index, described later, is similar to that given above. Since the polishing itself belongs to the prior art, the detail description thereabout will be omitted here.

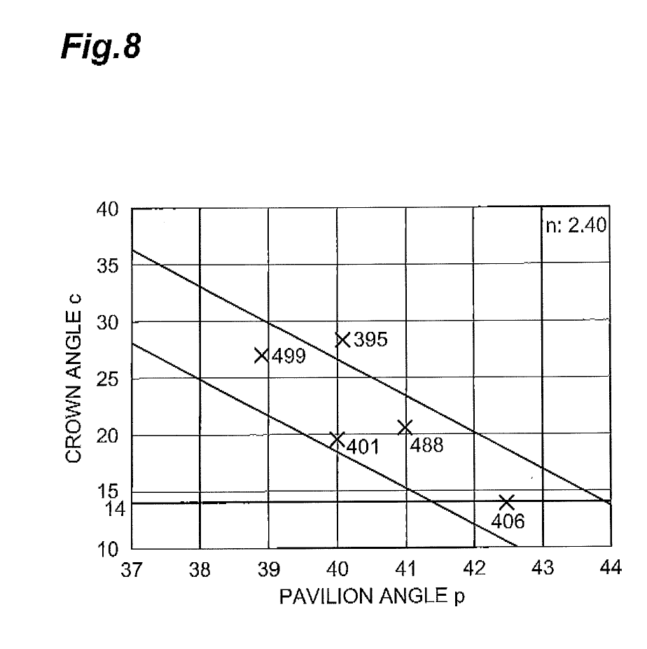

Next, for the color stone 1 that has 400 or higher reflection evaluation index, which color stone 1 is accepted as the viewer feels more beauty, the correlation between the pavilion angle p and the crown angle c is determined for each refractive index n. First, the correlation was determined for the case of color stone 1 with the refractive index n of 2.40. In FIG. 8, the correlation is shown by the range in which the pavilion angle p has a value of 37 to 44 degrees, and the crown angle c has a value of 10 to 40 degrees. As a result, for the color stone 1 with the refractive index n of 2.40, the reflection evaluation index became 400 or more in the domain encircled by the formulae (13) and (14) below, and further stably the reflection evaluation index became 400 or more in the domain encircled by the formulae (13) to (17) below. Meanwhile, for the case of the color stone with the refractive index n of 2.30, similar tendency appeared, and for the case of the color stone 1 with the refractive index n of 2.30 to 2.40, more stably reflection evaluation index became 400 or more at the crown angle c of 14 degrees or larger.

c=−3.2385×p+156.1213 (13)

c=−3.2385×p+148.1213 (14)

p=38 (15)

p=43 (16)

c=14 (17)

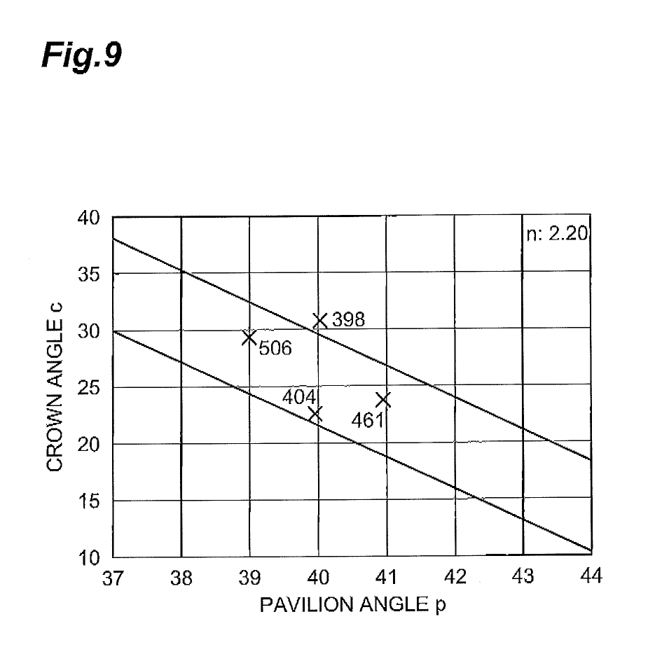

Next, the correlation was determined for the case of color stone 1 with the refractive index n of 2.20. In FIG. 9, the correlation is shown by the range in which the pavilion angle p has a value of 37 to 44 degrees and the crown angle c has a value of 10 to 40 degrees. As a result, for the color stone 1 with the refractive index n of 2.20, the reflection evaluation index became 400 or more in the domain encircled by the formulae (18) and (19) below, and further stably the reflection evaluation index became 400 or more in the domain encircled by the formulae (15), (16), (18), and (19) below.

c=−2.8114×p+142.0563 (18)

c=−2.8114×p+134.0563 (19)

p=38 (15)

p=43 (16)

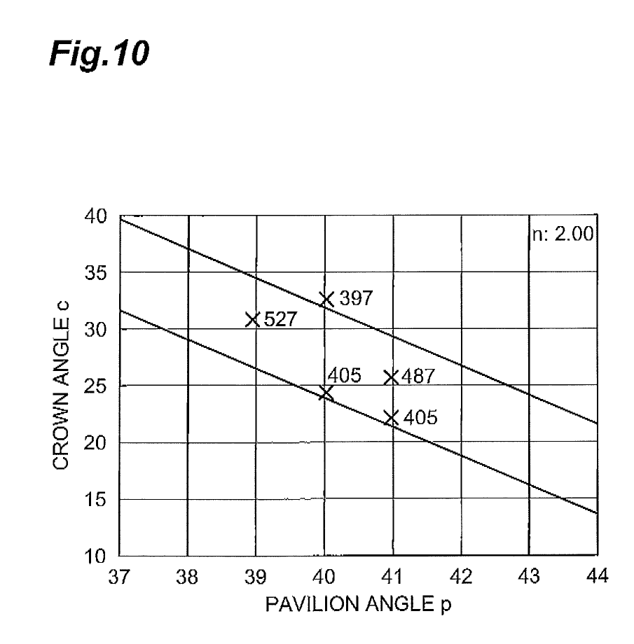

Next, the correlation was determined for the case of color stone 1 with the refractive index n of 2.00. In FIG. 10, the correlation is shown by the range in which the pavilion angle p has a value of 37 to 44 degrees and the crown angle c has a value of 10 to 40 degrees. As a result, for the color stone 1 with the refractive index n of 2.00, the reflection evaluation index became 400 or more in the domain encircled by the formulae (20) and (21) below, and further stably the reflection evaluation index became 400 or more in the domain encircled by the formulae (15), (16), (20), and (21) below.

c=−2.564×p+134.44 (20)

c=−2.564×p+126.44 (21)

p=38 (15)

p=43 (16)

Here, by determining the correlation for the case of color stone 1 with the refractive index n of 2.00 to 2.40 in a general formula, for the color stone 1 with the refractive index n of 2.00 to 2.40, the reflection evaluation index became 400 or more in the domain encircled by the formulae (22) and (23) below, and further stably the reflection evaluation index became 400 or more in the domain encircled by the formulae (15), (16), (22), and (23) below.

c=−A(n)×p+B(n)+K1 (22)

c=−A(n)×p+B(n)+K2 (23)

p=38 (15)

p=43 (16)

where, A(n) in the formula (22) and the formula (23) is represented by the formula (2),

A(n)=−1.122×n⁵+9.14×n⁴−26.752×n³+32.982×n²−12.842×n (2)

B(n) in the formula (22) and formula (23) is represented by the formula (3),

B(n)=−22.323×n⁵+184.166×n⁴−527.616×n³+594.102×n²−128.68×n (3)

K1 in the formula (22) is represented by the formula (4),

K1=+4 (4)

K2 in the formula (23) is represented by the formula (5),

K2=−4 (5)

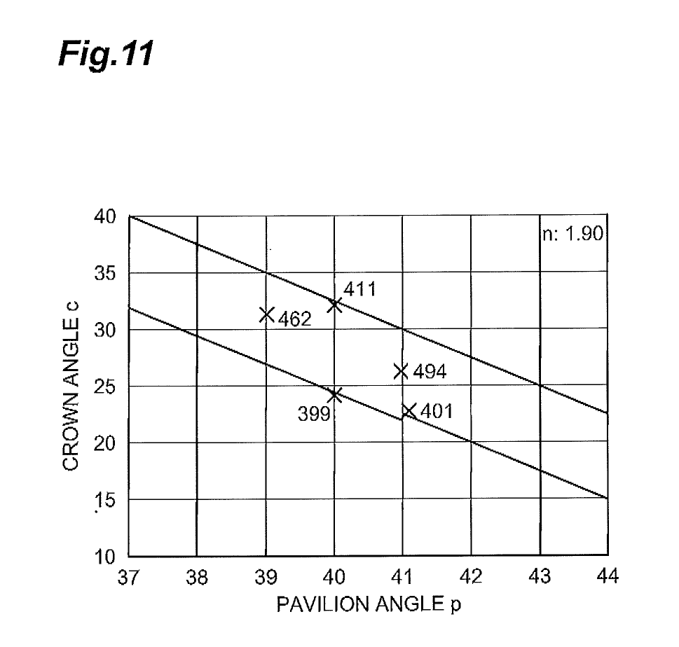

Next, the correlation was determined for the case of color stone 1 with the refractive index n of 1.90. In FIG. 11, the correlation is shown by the range in which the pavilion angle p has a value of 37 to 44 degrees and the crown angle c has a value of 10 to 40 degrees. As a result, for the color stone 1 with the refractive index n of 1.90, the reflection evaluation index became 400 or more in the domain encircled by the formulae (24) and (25) below, and further stably the reflection evaluation index became 400 or more in the domain encircled by the formulae (15), (16), (24) to (26) below, (however, for the case of pavilion angle p of 38 to 41 degrees, the formula (25) is applied, and for the case of pavilion angle p of more than 41 degrees and not more than 43 degrees, the formula (26) is applied.)

c=−2.505×p+132.6282 (24)

c=−2.505×p+124.6282 (25)

(for the case of p of 38 to 41 degrees)

c=−2.505×p+125.2271 (26)

(for the case of p of more than 41 degrees and not more than 43 degrees)

p=38 (15)

p=43 (16)

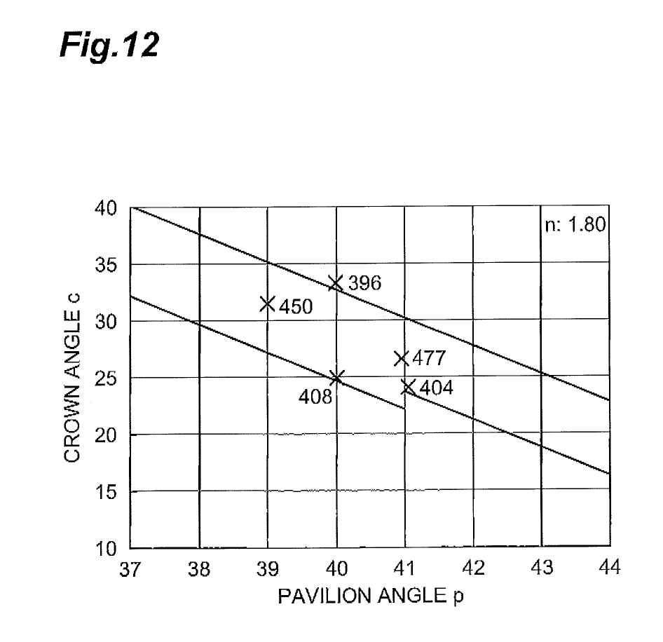

Next, the correlation was determined for the case of color stone 1 with the refractive index n of 1.80. In FIG. 12, the correlation is shown by the range in which the pavilion angle p has a value of 37 to 44 degrees and the crown angle c has a value of 10 to 40 degrees. As a result, for the color stone 1 with the refractive index n of 1.80, the reflection evaluation index became 400 or more in the domain encircled by the formulae (27) and (28) below, and further stably the reflection evaluation index became 400 or more in the domain encircled by the formulae (15), (16), (27) to (29) below, (however, for the case of pavilion angle p of 38 to 41 degrees, the formula (28) is applied, and for the case of pavilion angle p of more than 41 degrees and not more than 43 degrees, the formula (29) is applied.)

c=−2.4755×p+131.7027 (27)

c=−2.4755×p+123.7027 (28)

(for the case of p=38 to 41 degrees)

c=−2.4755×p+125.2476 (29)

(for the case of p of more than 41 degrees and not more than 43 degrees)

p=38 (15)

p=43 (16)

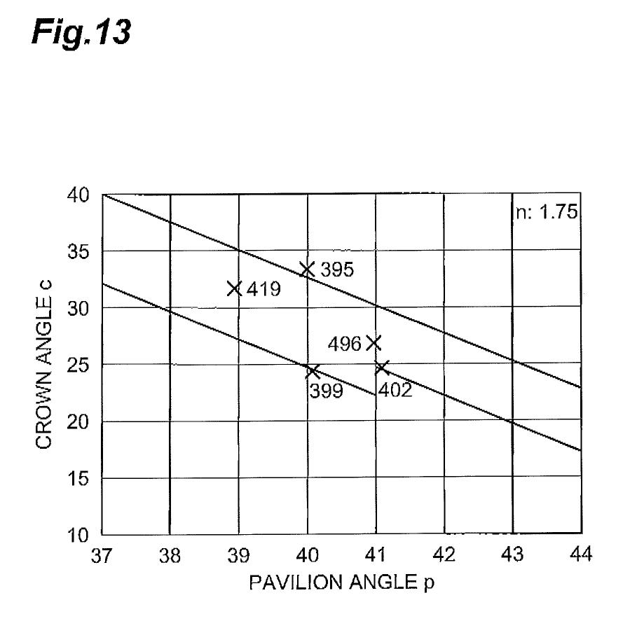

Next, the correlation was determined for the case of color stone 1 with the refractive index n of 1.75. In FIG. 13, the correlation is shown by the range in which the pavilion angle p has a value of 37 to 44 degrees and the crown angle c has a value of 10 to 40 degrees. As a result, for the color stone 1 with the refractive index n of 1.75, the reflection evaluation index became 400 or more in the domain encircled by the formulae (30) and (31) below, and further stably the reflection evaluation index became 400 or more in the domain encircled by the formulae (15), (16), (30) to (32) below, (however, for the case of pavilion angle p from 38 to 41 degrees, the formula (31) is applied, and for the case of pavilion angle p of more than 41 degrees and not more than 43 degrees, the formula (32) is applied.)

c=−2.4676×p+131.4417 (30)

c=−2.4676×p+123.4417 (31)

(for the case of p of 38 to 41 degrees)

c=−2.4676×p+125.884 (32)

(for the case of p of more than 41 degrees and not more than 43 degrees)

p=38 (15)

p=43 (16)

Here, by determining the correlation for the case of color stone 1 with the refractive index n of 1.75 to 1.90 in a general formula, for the color stone 1 with the refractive index n of 1.75 to 1.90, the reflection evaluation index became 400 or more in the domain encircled by the formulae (22) and (23) below, and further stably the reflection evaluation index became 400 or more in the domain encircled by the formulae (15), (16), (22), and (23) below.

c=−A(n)×p+B(n)+K1 (22)

c=−A(n)×p+B(n)+K2 (23)

p=38 (15)

p=43 (16)

where, A(n) in the formula (22) and the formula (23) is represented by the formula (2),

A(n)=−1.122×n⁵+9.14×n⁴−26.752×n³+32.982×n²−12.842×n (2)

B(n) in the formula (22) and formula (23) is represented by the formula (3),

B(n)=−22.323×n⁵+184.166×n⁴−527.616×n³+594.102×n²−128.68×n (3)

K1 in the formula (22) is represented by the formula (4),

K1=+4 (4)

When p is from 38 to 41 degrees, K2 in the formula (23) is represented by the formula (5),

K2=−4 (5)

When P is more than 41 degrees and not more than 43 degrees, K2 is represented by the formula (6),

K2=−10.526(0.38²−(n−2.1²)^{1/2} (6)

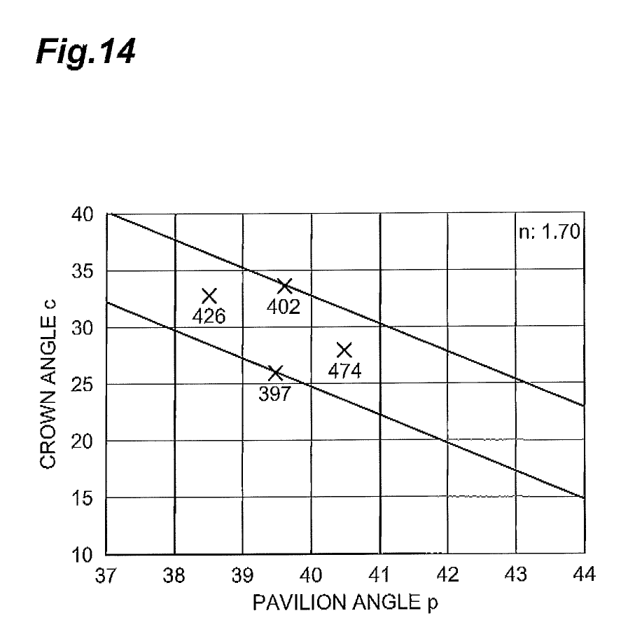

Next, the correlation was determined for the case of color stone 1 with the refractive index n of 1.70. In FIG. 14, the correlation is shown by the range in which the pavilion angle p has a value of 37 to 44 degrees and the crown angle c has a value of 10 to 40 degrees. As a result, for the color stone 1 with the refractive index n of 1.70, the reflection evaluation index became 400 or more in the domain encircled by the formulae (25) and (26) below, and further stably the reflection evaluation index became 400 or more in the domain encircled by the formulae (15) and (25) to (27) below.

c=−2.4614×p+131.2395 (25)

c=−2.4614×p+123.2395 (26)

p=38 (15)

p=41 (27)

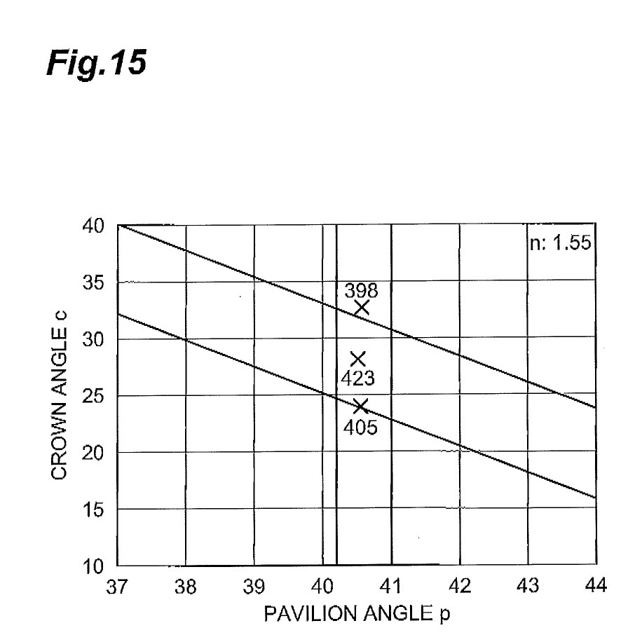

Next, the correlation was determined for the case of color stone 1 with the refractive index n of 1.55. In FIG. 15, the correlation is shown by the range in which the pavilion angle p has a value of 37 to 44 degrees and the crown angle c has a value of 10 to 40 degrees. As a result, for the color stone 1 with the refractive index n of 1.55, the reflection evaluation index became 400 or more in the domain encircled by the formulae (28) and (29) below, and further stably the reflection evaluation index became 400 or more in the domain encircled by the formulae (27) to (30) below.

c=−2.4311×p+130.3922 (28)

c=−2.4311×p+122.3922 (29)

p=40.2(critical angle) (30)

p=41 (27)

When the refractive index n is smaller than 1.64, the pavilion angle p may become 38 to 40.2 degrees, which is smaller than the critical angle. When the pavilion angle p becomes smaller than the critical angle, reflection occurs on the pavilion face to lose the light moving toward the table surface 11 and the crown main facet 12, and thus extremely decreases the reflection evaluation index becomes lowered. In order to cope with the phenomenon, when the refractive index n is, for example, 1.55, the pavilion angle p is selected so as to become larger than the critical angle (40.2 degrees). The critical angle is determined by sin⁻¹(1/n).

Here, by determining the correlation for the case of color stone 1 with the refractive index n of 1.55 to 1.70 in a general formula, for the color stone 1 with the refractive index n of 1.55 to 1.70, the reflection evaluation index became 400 or more in the domain encircled by the formulae (22) and (23) below, and further stably the reflection evaluation index became 400 or more in the domain encircled by the formulae (22), (23), (27), and (31) below.

c=−A(n)×p+B(n)+K1 (22)

c=−A(n)×p+B(n)+K2 (23)

p=38(or the critical angle) (31)

p=41 (27)

where, A(n) in the formula (22) and the formula (23) is represented by the formula (2),

A(n)=−1.122×n⁵+9.14×n⁴−26.752×n³+32.982×n²−12.842×n (2)

B(n) in the formula (22) and formula (23) is represented by the formula (3),

B(n)=−22.323×n⁵+184.166×n⁴−527.616×n³+594.102×n²−128.68×n (3)

K1 in the formula (22) is represented by the formula (4),

K1=+4 (4)

K2 in the formula (23) is represented by the formula (5),

K2=−4 (5)

As described above in detail, according to the color stone 1 and the cutting method of color stone 1 of the embodiment, the pavilion angle p and the crown angle c satisfy the correlation represented by the general formula (1), −A(n)×p+B(n)+K1≧c≧−A(n)×p+B(n)+K2. By substituting any of different refractive indexes n of 1.55 to 2.40 to the correlation of the formula (1) and thus establishing the cut-design in which the pavilion angle p and the crown angle c are determined, the “amount of reflection light on visual perception” can be increased depending on the refractive index n. Then, for example, the reflection evaluation index can be increased to 400 or more. A viewer of that cut-designed color stone 1 can feel further beautiful brightness. In addition, according to the formula (1), since the pavilion angle p and the crown angle c can be determined depending on the refractive index n, the cutting condition capable of increasing the “quantity of reflection light on visual perception” can be commonly used among the different kinds of color stones.

Meanwhile, according to the embodiment, the description is given for the cases of applying the present invention to a color stone which is a colored decorative jewel. The present invention, however, can be applied to colorless transparent decorative jewel formed of a material with the refractive index n of 1.55 to 2.40.

### INDUSTRIAL APPLICABILITY

The present invention can be used as a decorative jewel subjected to a cutting design which allows viewers to feel that brightness of color stones is further beautiful,

### REFERENCE SIGNS LIST

1: Color stone (decorative jewel)
10: Crown part
11: Table surface
12: Crown main facet
13: Star facet
14: Upper girdle facet
20: Pavilion part
21: Pavilion main facet
22: Lower girdle facet
30: Girdle part
G: Culet
O: Center

1. A decorative jewel formed of a material with a refractive index n of 1.55 to 2.40 and being subjected to brilliant-cutting, the pavilion angle p being smaller than 41 degrees, and the pavilion angle p and the crown angle c satisfying the formula (1),
−A(n)×p+B(n)+K1≧c≧−A(n)×p+B(n)+K2 (1)
where, A(n) in the formula (1) is represented by the formula (2),
A(n)=−1.122×n⁵+9.14×n⁴−26.752×n³+32.982×n²−12.842×n (2)
B(n) in the formula (1) is represented by the formula (3),
B(n)=−22.323×n⁵+184.166×n⁴−527.616×n³+594.102×n²−128.68×n (3)
K1 in the formula (1) is represented by the formula (4),
K1=+4 (4)
K2 in the formula (1) is represented by the formula (5),
K2=−4 (5).

2. The decorative jewel according to claim 1, wherein, when the refractive index n is larger than 1.70 and not larger than 2.40, the pavilion angle p is from 38 degrees or larger and smaller than 41 degrees.

3. The decorative jewel according to claim 1, wherein, when the refractive index n is from 2.30 to 2.40, the crown angle c is 14 degrees or larger.

4. The decorative jewel according to claim 1, wherein, when the refractive index n is from 1.55 to 1.70, the pavilion angle p is from 38 degrees or larger and smaller than 41 degrees and larger than the critical angle, sin⁻¹(1/n).

5. The decorative jewel according to claim 1, wherein the material is composed of any one of ruby, sapphire, zirconia, emerald, aquamarine, tourmaline, and alexandrite.

6. A method of cutting a decorative jewel formed of a material with a refractive index n of 1.55 to 2.40 and being subjected to brilliant-cutting, the method comprising the step of cutting thereof so that the pavilion angle p becomes smaller than 41 degree, and so that the pavilion angle p and the crown angle c satisfy the formula (1),
−A(n)×p+B(n)+K1≧c≧−A(n)×p+B(n)+K2 (1)
where, A(n) in the formula (1) is represented by the formula (2),
A(n)=−1.122×n⁵+9.14×n⁴−26.752×n³+32.982×n²−12.842×n (2)
B(n) in the formula (1) is represented by the formula (3),
B(n)=−22.323×n⁵+184.166×n⁴−527.616×n³+594.102×n²−128.68×n (3)
K1 in the formula (1) is represented by the formula (4),
K1=+4 (4)
K2 in the formula (1) is represented by the formula (5),
K2=−4 (5).
